(19) United States
(12) Patent Application Publication
(10) Pub. No.: US 2008/0010041 A1
(43) Pub. Date: Jan. 10, 2008

(54) Assembling physical simulations in a 3D graphical editor

(75) Inventor: Richard Gary McDaniel, Hightstown, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS TECHNOLOGY-TO-BUSINESS CENTER LLC, Berkeley, CA (US)

(21) Appl. No.: 11/603,462

(22) Filed: Nov. 21, 2006

Related U.S. Application Data
(60) Provisional application No. 60/819,055, filed on Jul. 7, 2006.

(51) Int. Cl. G06F 17/50

(52) U.S. Cl. 703/1

(57) ABSTRACT

Systems and methods for graphical simulation of physical objects are presented. Embodiments of the present invention contemplate using 3D widgets to represent physical objects as well as semantic relationships such as joints and constraints between objects. Interactive graphical markers are also used to directly manipulate properties such as material properties of objects and connection and attachment of blocks and joints.

### REFERENCE TO EARLIER-FILED APPLICATIONS

This application claims the benefit of and hereby incorporates by reference U.S. Provisional Application 60/819,055 filed Jul. 7, 2006 entitled “Assembling Physical Simulations in a 3D Graphical Editor.”

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This invention is related to 3D graphical editors and physical simulation.

### BACKGROUND

A graphical editor is an interactive program where a user adds objects to a graphical space or graphical environment. Examples of 3D graphical editors include computer-aided design (CAD) tools, 3D rendering tools, 3D modeling tools, and world editors for video and computer games. A user of a 3D graphical editor may select and manipulate graphical objects, for example, by clicking on and dragging them using an input device such as a mouse or a pen. The 3D graphical editor may produce objects that are displayed graphically in a main viewing window.

A 3D graphical editor may be adapted, in some cases, to visualize physical simulations, or graphical simulations of physical objects. Physical simulation comes in many forms. Rigid body simulations and its derivatives are a family of physical simulations where interacting physical objects are separate and can be depicted in a manner visually similar to their appearance in reality. Rigid body simulations may be visualized in a 3D graphical environment in conjunction with a physics engine.

A physics engine has two main components: a collision detection algorithm for determining when two or more physical objects come into contact, and a constraint resolution algorithm that applies the laws of motion to the objects and maintains all constraints defined by collisions and by the user. In some cases, a user does not have to program these algorithms directly but instead defines high-level physical objects for the simulation. Some systems in which a user constructs a simulation using a physics engine involve using a programming language. The language is separate from the 3D graphical objects in the main view. In the language, the user defines the physical objects within the simulation and the relationships among the objects. The language is used to create the simulation either by compiling it into executable code or using an interpreter that executes the simulation directly. Only when the simulation runs does the visual appearance of the objects appear in the 3D view. The 3D layout and appearance of the objects is typically not available when the simulation objects are configured and defined.

A common way to use a physics engine is for the user to write and compile a program in a standard language like C++. The physics engine is included as a programming library or API. The Open Dynamics Engine (ODE) physics engine is deployed this way. There are also systems where the user writes a physical simulation using a custom language such as ThreeDimSim. The custom language streamlines syntactic issues that arise when using standard programming languages. A custom language may also be interpreted directly instead of having to first be compiled. Another option is to construct the simulation using a dataflow language such as Simulink. In each of these cases, the user specifies the simulation objects using a secondary language. The 3D visual appearance and layout of the simulation entities is only rendered after the simulation program is compiled and executed.

Some CAD tools such as the UGS Motion Package use menu commands to specify physical simulation parameters. The CAD tool only displays visible physical entities in the graphical view. Visible physical entities are those that have a geometric shape and surface, whereas semantic objects that define the behavioral aspects of the simulation are not displayed graphically. Instead, the user selects the graphical objects and defines semantic relationships using menu commands. The system tracks the relationships internally and may provide a textual display of what was created but does not display 3D graphical objects to represent the relationships.

Different physics engines will define their architecture using different nomenclature and models, but they all have a hierarchical scheme defined by a finite set of object types. They will also define roughly the same set of parameters, though the parameters can be divided among object types differently.

### SUMMARY

According to specific embodiments, the present invention provides a method for specifying parameters and constraints in a physical simulation using a physics engine. The method defines user interaction methods that are applied in a three-dimensional (3D) graphical editor. The graphical editor is used to both define the simulation and to visualize the resulting behavior.

According to specific embodiments, the present invention defines new graphical interaction techniques for defining a physical simulation within a 3D graphical editor. In accordance with a specific embodiment, the method includes visual markers that are drawn within the context of a 3D graphical editor. The user manipulates these markers to specify the constraints and properties of the objects being depicted. The objects represent the appearance and 3D layout of physical entities such as the parts of a machine.

The present invention defines “3D widgets” that represent physical body and block entities as well as joint constraints, in accordance with a specific embodiment. The shape of the 3D widget represents the kind of entity or constraint being defined and the position and orientation of the 3D widget represent properties that are important to that kind of entity or constraint. The user manipulates the position and orientation of the 3D widget as though it were a typical graphical entity such as a geometric shape.

The present invention defines “markers” that are drawn near graphical objects that allow the user to view and modify relationships among the simulation entities and constraints, in accordance with a specific embodiment. “Material” markers are displayed near block entities. The material markers are used to access the block's material properties, and to share materials between blocks. “Part” markers are displayed near body entities and the blocks entities that are part of the body. The part markers indicate which blocks are parts of a body and may be used to add and remove blocks from that body. “Join” markers are displayed near joint constraints or the entities that a joint constraint affects. The user may change which entities the joint will affect by dragging its join markers to different graphical objects.

In one embodiment, a graphical simulation system for physical simulation of 3D objects includes a display, a memory containing a graphical simulation program with program code for physical simulation of 3D objects, and a processor operatively connected to the memory and the display. The processor is adapted to execute the graphical simulation program with the program code adapted to cause the processor to instantiate a 3D graphical editor, assemble a physical simulation via the 3D graphical editor, and initiate a physical simulation session to manipulate one or more of the properties of the 3D objects and widgets. The physical simulation is assembled by creating a graphical representation of 3D objects with properties via the 3D graphical editor, and creating widgets via the 3D graphical editor, each widget representing a 3D object or a semantic relationship to at least one 3D object. The properties of each of the 3D objects may include one or more of mass, position, orientation, and motion properties. The motion properties may include one or more of velocity, acceleration and inertia. As for widgets, the properties of each widget may include one or more of shape, position, and orientation. The widgets may be 3D shaped, and may include one or more of entity widgets, axis widgets, and constraint widgets. The widgets may include one or more joints and each semantic relationship associated with a joint may represent a connection to one of the 3D objects, a connection between 3D objects, or a connection to another joint. The program code may be further adapted to cause the processor to display a joint widget via the 3D graphical editor if the joint properties are defined, if the joint is selected, if a connected object is selected, or if a selected object can be used as a connection to the joint. As for types of joints, the one or more joints may include a gear, a hinge, a cylindrical joint, a prismatic joint, or a ball joint. Such a graphical simulation system may further be enhanced by having the program code be further adapted to cause the processor to create one or more blocks when assembling the physical simulation, wherein each block represents a geometric shape and a surface. In such a system, each block may be associated with one or independent from all of the 3D objects. Additionally, each block may have properties including one or more of position, orientation, geometric shape and material. Such a system may also be enhanced by having the 3D graphical editor being adapted to provide palettes and wherein the blocks and objects represented by widgets are selectable from the palettes. The graphical simulation system may also be enhanced by having the 3D graphical editor adapted to display widgets during the assembly or editing of the physical simulation. The 3D graphical editor may or may not display widgets during visualization or during the physical simulation session. The graphical simulation system may be further enhanced by having the program code being further adapted to cause the processor to create one or more markers when assembling the physical simulation, wherein each marker is initially associated with a 3D object or a widget and can be dragged to another 3D object or widget. Each such marker may be a material marker, a part marker, or a join marker. Material markers may specify material properties of objects including one or more of friction and restitution, whereas part markers may specify groupings and attachments of blocks, and join markers may specify connections of joints to one or more blocks. In such a system, the graphical editor may be adapted to add a block or replace a block in a body when a part marker is dragged over a block or remove a block when a part marker is dragged away from a body.

In another embodiment, a method for physical simulation of 3D objects includes instantiating a 3D graphical editor, assembling a physical simulation via the 3D graphical editor, and initiating a physical simulation session to manipulate one or more of the properties of the 3D objects and widgets. The physical simulation is assembled by creating a graphical representation of 3D objects with properties via the 3D graphical editor, and creating widgets via the 3D graphical editor, each widget representing a 3D object or a semantic relationship to at least one 3D object. The properties of each of the 3D objects may include one or more of mass, position, orientation, and motion properties. The motion properties may include one or more of velocity, acceleration and inertia. As for widgets, the properties of each widget may include one or more of shape, position, and orientation. The widgets may be 3D shaped, and may include one or more of entity widgets, axis widgets, and constraint widgets. The widgets may include one or more joints and each semantic relationship associated with a joint may represent a connection to one of the 3D objects, a connection between 3D objects, or a connection to another joint. A joint may be displayed if the joint properties are defined, if the joint is selected, if a connected object is selected, or if a selected object can be used as a connection to the joint. As for types of joints, the one or more joints may include a gear, a hinge, a cylindrical joint, a prismatic joint, or a ball joint. Such a method may further be enhanced by creating one or more blocks when assembling the physical simulation, wherein each block represents a geometric shape and a surface. In such a method, each block may be associated with one or independent from all of the 3D objects. Additionally, each block may have properties including one or more of position, orientation, geometric shape and material. Such a method may also be enhanced by having the 3D graphical editor being adapted to provide palettes and wherein the blocks and objects represented by widgets are selectable from the palettes. The method may include displaying widgets during the assembly or editing of the physical simulation. The method may include displaying or not displaying widgets during visualization or during the physical simulation session. The method may be further enhanced by creating one or more markers when assembling the physical simulation, wherein each marker is initially associated with a 3D object or a widget and can be dragged to another 3D object or widget. Each such marker may be a material marker, a part marker, or a join marker. Material markers may specify material properties of objects including one or more of friction and restitution, whereas part markers may specify groupings and attachments of blocks, and join markers may specify connections of joints to one or more blocks. For such a method, the dragging of a part marker over another block may add or replace a block in a body, and dragging a part marker away from a body may remove a block from the body.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates a system for physical simulation of 3D graphical objects according to one embodiment of the present invention.

FIG. 2 illustrates a user interface for a 3D graphical editor and physical simulation system according to one embodiment of the present invention.

FIG. 3 illustrates examples of physical objects and widgets according to one embodiment of the present invention.

FIG. 4 illustrates a widget for a hinge along with the objects it constrains according to one embodiment of the present invention.

FIG. 5 illustrates a physical arrangement of a hinge joint widget and the two physical objects it joins and constrains at three different zoom levels according to one embodiment of the present invention.

FIGS. 6A and 6B illustrate an entity widget used to represent a physical block before and after a geometry property is defined, respectively, according to one embodiment of the present invention.

FIGS. 7A and 7B illustrate an entity widget used to represent a physical body before and after its constituent pieces are specified, respectively, according to one embodiment of the present invention.

FIG. 8 presents a flow diagram for a method 800 for determining whether to display a 3D widget for a joint according to one embodiment of the present invention.

FIGS. 9A and 9B illustrate how the alignment of a hinge joint affects the objects that it constrains according to one embodiment of the present invention.

FIG. 10 illustrates a gear joint being used to constrain two hinge joints according to one embodiment of the present invention.

FIG. 11 illustrates the process of sharing a material between two blocks using material markers according to one embodiment of the present invention.

FIG. 12 illustrates how different materials are indicated by different material markers according to one embodiment of the present invention.

FIG. 13 illustrates the use of part markers to add blocks to a body according to one embodiment of the present invention.

FIG. 14 illustrates the use of part markers to remove blocks from a body according to one embodiment of the present invention.

FIGS. 15A and 15B present a flow diagram of a method 1500 for adding, removing, and replacing blocks using markers according to one embodiment of the present invention.

FIG. 16 illustrates the use of join markers according to one embodiment of the present invention.

### DETAILED DESCRIPTION OF SPECIFIC EMBODIMENTS

In the following detailed description, reference is made to the accompanying drawings in which are shown by way of illustration a number of embodiments and the manner of practicing the invention. It is to be understood that other embodiments may be utilized and structural changes may be made without departing from the scope of the present invention.

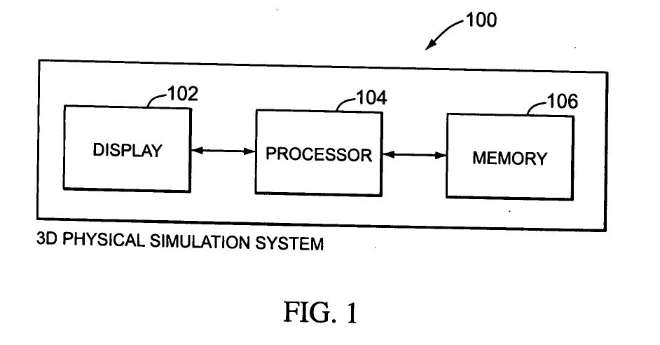

FIG. 1 illustrates a system for physical simulation of 3D graphical objects according to one embodiment of the present invention. According to FIG. 1, a 3D physical simulation system 100 comprises a processor 104 coupled to a display 102 and a memory 106. The memory 106 may contain a program with program code for physical simulation of 3D graphical objects. The program may provide a 3D graphical editor as well as an underlying physics engine for producing the simulation. The processor 104 executes the program code and displays the output on display 102.

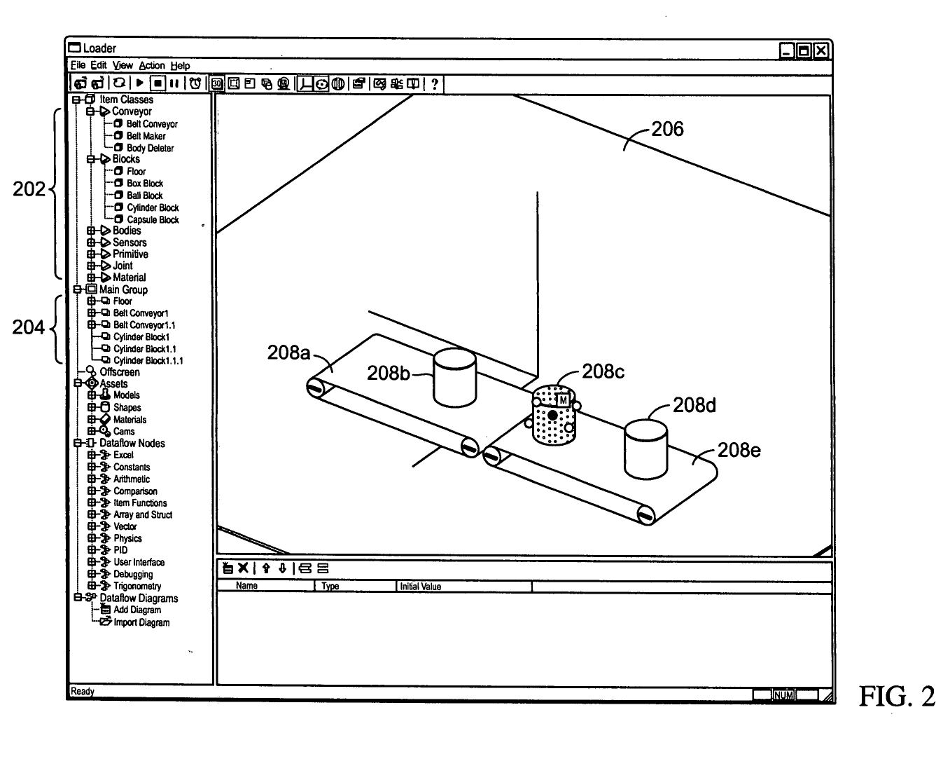

FIG. 2 illustrates a user interface for a 3D graphical editor and physical simulation system according to one embodiment of the present invention. A user may select items from a palette 202 of various physical objects including bodies, blocks, joints, and materials. The user may manipulate the items by clicking and dragging them into a 3D view/edit region 206 using, for example, an input device such as a mouse or a pen. Once created, the items are listed in a list of items created 204 and displayed as items 208a-e.

In these embodiments, a “body” may represent a physical object that can move about in 3D space. The properties of a body may include position, orientation, mass, velocity, acceleration, and inertia. Also, a “block” may be a physical object that represents the geometric shape and surface of an entity. Blocks and bodies form a hierarchy where a body contains one or more blocks. The body represents the motion of the entity whereas the set of blocks comprising the body represents the entity's shape. A block may also be independent of a body (e.g., it may represent an immobile barrier to the motion of other entities). The parameters for a block may include position and orientation, geometry designation or shape type (e.g., cube, sphere, or a mesh surface), and a “material” type. The geometry specifies the block's actual size and shape. A “material” type influences how two bodies will interact when they collide. Material properties may include friction and restitution. A material may be an object that is stored with a block. In these embodiments, a “joint” is used to represent a connection between two physical objects, such as bodies or even other joints. Different kinds of joints represent different ways that the entities can be constrained. For example, a “hinge” joint constrains two bodies so that they share a common axis about which both can rotate. On the other hand, a “gear” joint defines a constraint between two axis-like joints. A gear attached to two hinge joints will constrain one hinge to turn a proportional number of times that the other hinge turns and vice versa. There are many kinds of joints each having different constraining properties and semantics that are useful for specifying a multitude of physical situations.

Embodiments of the present invention define three kinds of 3D widgets. “Entity” widgets stand in for physical entities that would normally be visible. When a physical entity such as a body or block is first created, its properties can be undefined in its default state. If the properties that define its physical appearance are unspecified, the present invention provides an entity widget to stand in for the unknown appearance. “Axis” widgets represent joints that have positional and/or directional property components. For example, a hinge joint between two bodies is parameterized by an axis of rotation. The direction of the axis determines the shared plane of rotation between the two bodies and the position of the axis determines which point within the bodies about which each will rotate. “Constraint” widgets represent joints that do not have explicit geometric properties. These kinds of joints are made visible as 3D widgets for consistency and for the convenience of the user. For example, a gear joint defines a relationship between two axis joints. While the axis joints have positional information, the gear relationship itself is not spatial so the gear joint's 3D widget position is not consequential to its operation.

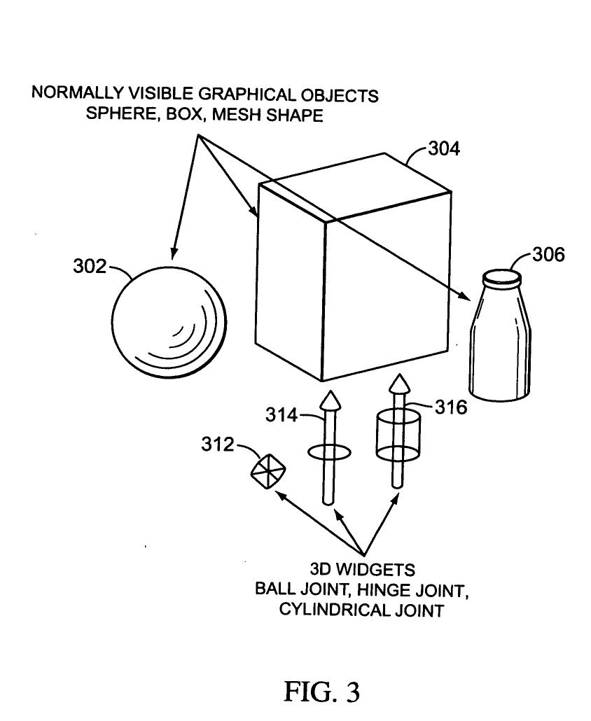

FIG. 3 illustrates examples of physical objects and widgets according to one embodiment of the present invention. Preferably, 3D widgets are displayed using a similar look with a common color scheme. For example, the 3D widgets are drawn in a manner that is distinct from the graphical appearance of physical entities. In contrast to physical entities such as sphere 302, box 304, and mesh shape 306 that are drawn in a filled-in shaded mode with opaque or lightly transparent colors, 3D widgets such as ball joint 312, hinge joint 314, and cylindrical joint 316 are drawn as outlines using thick lines and with no shaded surfaces.

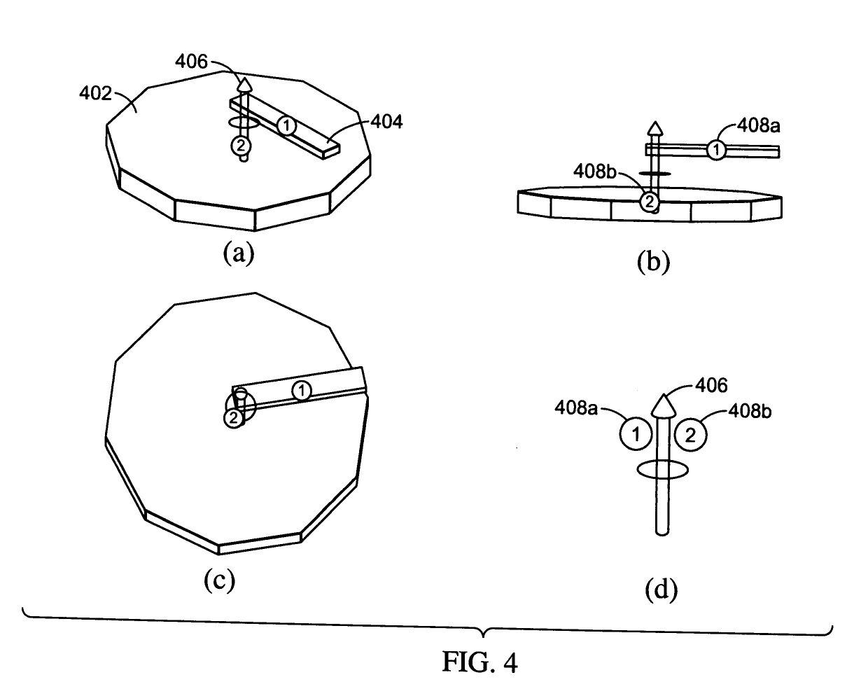

FIG. 4 illustrates a widget for a hinge along with the objects it constrains according to one embodiment of the present invention. A hinge joint represented by the hinge joint widget 406 joins and constrains bodies 402 and 404 as shown in (a). Markers 408a and 408b (which will be described in more detail later) indicate which physical objects are connected to the hinge joint widget 406, as shown in (b). The common axis of rotation is the z-axis, as shown in (b), so that body 404 rotates with respect to body 402 like a hand on a clock, as shown in (c). In (d), the hinge joint widget 406 is shown alone, and includes markers 408a and 408b. The 3D widgets are often co-located with other graphical objects and they are sometimes positioned within the boundary of those objects. To enable the user to always be able to select a 3D widget, the widgets are always drawn on top of other graphics regardless of their depth. The user can ascertain the 3D widget's location by rotating the scene in the view window. Although the hinge joint widget is embedded within the other objects, its widget 406 is kept visible during assembly or editing of the physical simulation

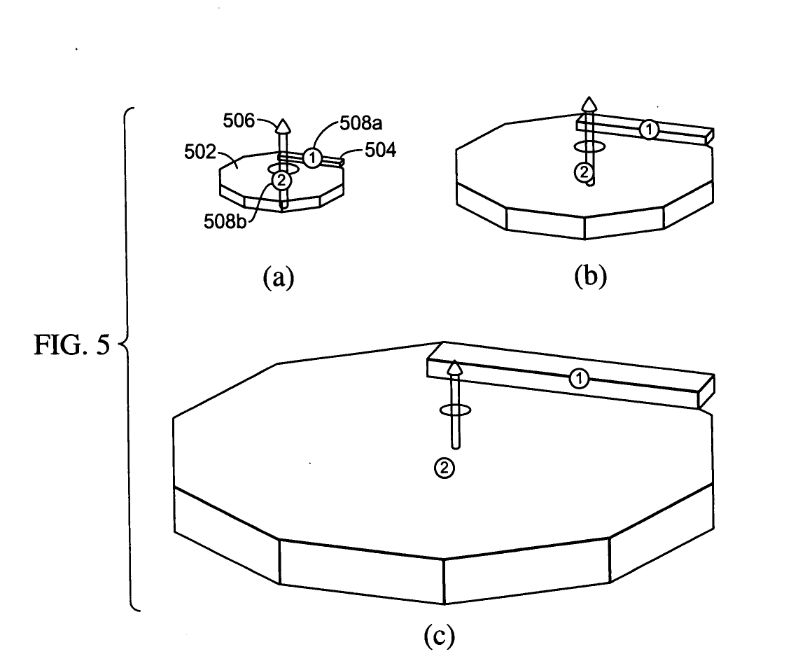

FIG. 5 illustrates a physical arrangement of a hinge joint widget and the two physical objects it joins and constrains at three different zoom levels (as in FIG. 4) according to one embodiment of the present invention. A hinge joint, represented by hinge joint widget 506 joins and constrains physical bodies 502 and 504, and markers 508a and 508b indicate the connection of bodies 502 and 504 to the hinge joint, respectively. Preferably, 3D widgets are scale independent. That is, the semantics of the object represented by the 3D widget do not depend on a size property. Accordingly, 3D widgets are always drawn the same size regardless of how much the user has zoomed in. When the user is zoomed out, visible 3D widgets seem relatively large compared to geometric physical entities. When the user is zoomed in, the 3D widgets seem relatively small. As shown, the size of hinge joint widget 506 and its markers 508a and 508b remain the same size in (a), (b), and (c).

Having generally described and illustrated some examples of widgets, each specific type will be described in more detail, beginning with entity widgets. An entity widget is a 3D widget that is used to stand in for a physical entity at times when that entity does not have a visible form of its own. Some properties of an entity, such as its size and geometry, determine a visual appearance but others, such as its position and velocity, do not. Embodiments of the present invention allow the user to manipulate a physical entity by its 3D widget even when the entity has no intrinsic visual appearance.

A first example of an entity widget is a “block” entity widget. In these embodiments, the physics engine preferably uses the “block” entity to represent a geometric shape. The geometry property of the block entity defines what shape the block will use. If the geometry property is undefined, the graphical editor substitutes a 3D entity widget for the block's appearance.

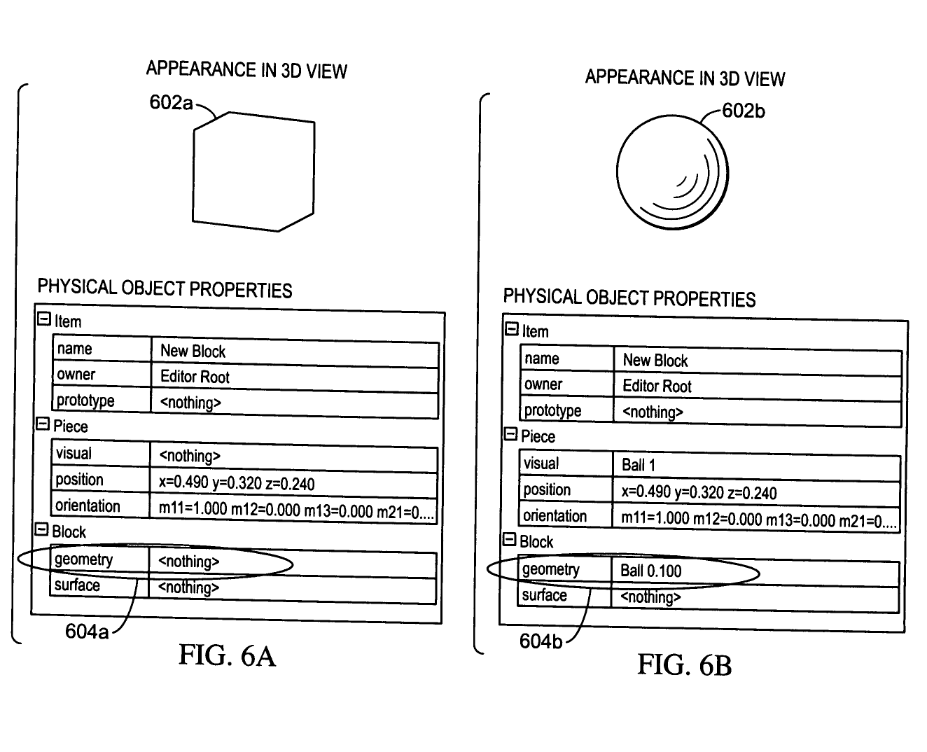

FIGS. 6A and 6B illustrate an entity widget used to represent a physical block before and after its geometry property is defined, respectively, according to one embodiment of the present invention. In FIG. 6A, block entity widget 602a is displayed for a block defined by the properties listed in the corresponding table, including “geometry” 604a. As shown, this physical block does not have a defined geometry property. Points stored in the geometry property of table are defined to be relative to the position and orientation of the block. This allows the user to set the position and orientation of the block even when its shape is not known. In FIG. 6B, the physical block is now represented by ball 602b, which corresponds with the block's geometry property as defined in the corresponding table and by “geometry” 604(b).

A second example of an entity widget is a “body” entity widget. A “body” entity of the physics engine represents an object that can move physically. Unlike a block, a body does not have its own geometry but instead is composed from block entities hierarchically. If the constituent pieces of the body are not specified, the graphical editor substitutes a 3D entity widget for the body's appearance.

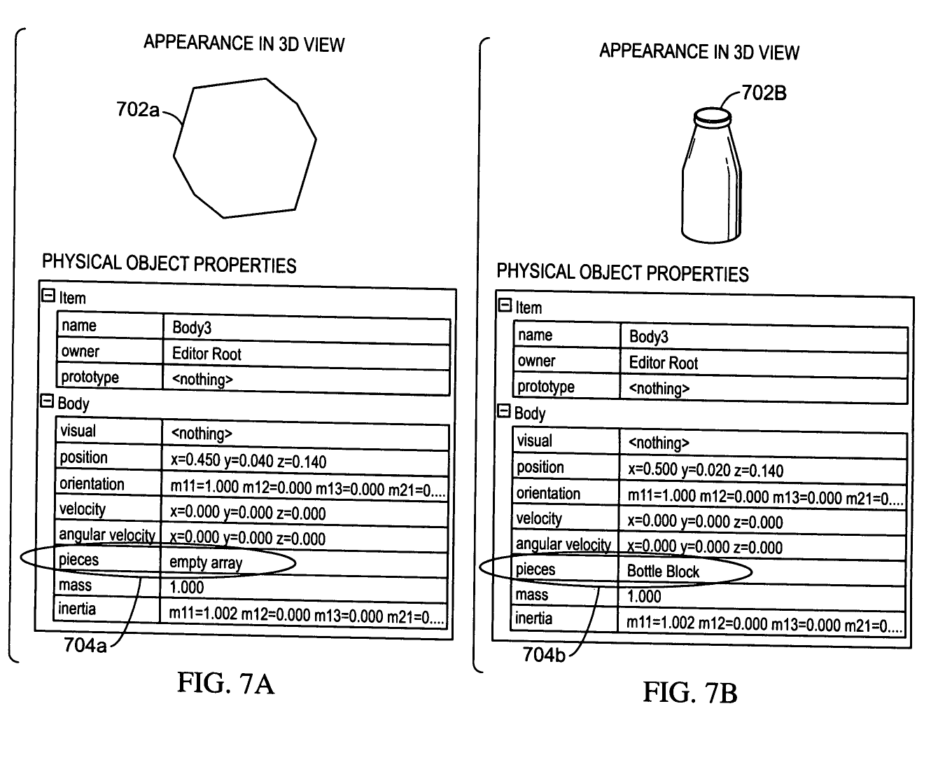

FIGS. 7A and 7B illustrate an entity widget used to represent a physical body before and after its constituent pieces are specified, respectively, according to one embodiment of the present invention. In FIG. 7A, body entity widget 702a is displayed for a physical body defined by the properties listed in the table, including “pieces” 704a. As shown, this physical body does not have its constituent pieces defined. In FIG. 7B, the physical body is now represented by the bottle shape 702b, which corresponds with the block's specified constituent pieces as defined by the table, including “pieces” 704b. Thus, a body object with no added blocks has no geometry and is drawn with a 3D widget. Once a block is added, the body's 3D widget is no longer shown, and is replaced by a drawing of the physical object. If the added block's shape is undefined, the block's 3D widget will be visible.

As described, blocks and bodies may be displayed as 3D widgets as needed. On the other hand, joints are semantic relationships and would not normally be physically visible. Accordingly, the 3D graphical editor displays these entities using 3D widgets. Displaying all joints all the time can be problematic because a simulation can require many constraints to specify how the physical objects behave. To reduce clutter, the 3D graphical editor may display 3D widgets for joints under certain conditions and hide them otherwise.

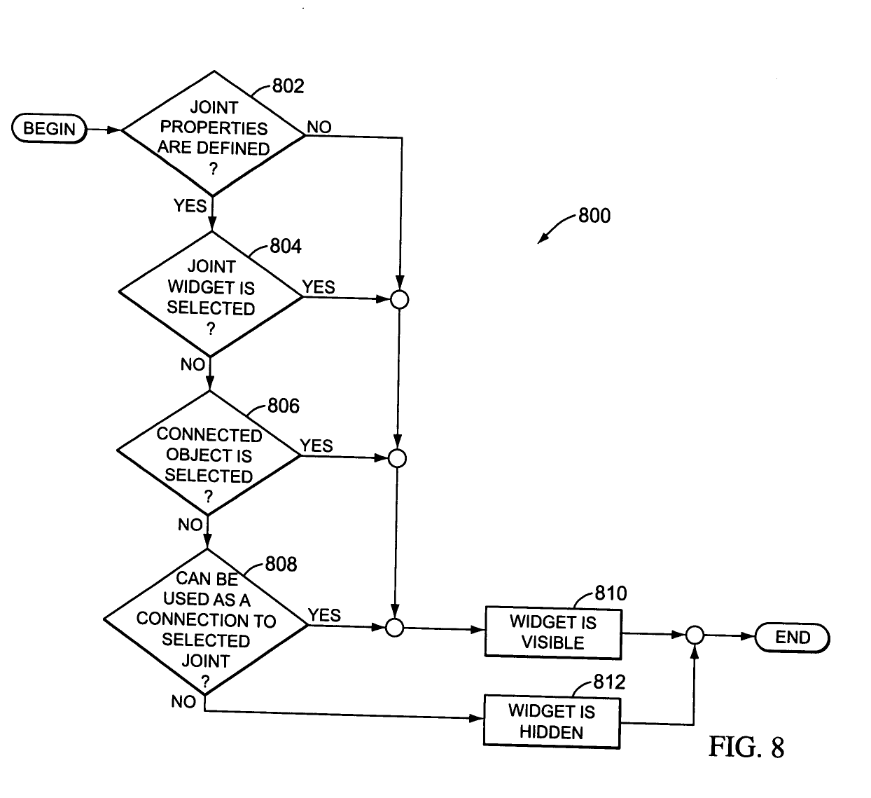

FIG. 8 presents a flow diagram for a method 800 for determining whether to display a 3D widget for a joint according to one embodiment of the present invention. First, the 3D widget is visible (810) if the joint's properties are not defined (802). For example, a hinge joint is connected to at least one body. If the joint is not yet connected or is not sufficiently connected, its 3D widget remains visible. Second, the 3D widget is visible (810) if it is selected (804). In this state, the 3D widget is colored differently from unselected 3D widgets to note its state. Third, the 3D widget is made visible (810) if an object that it connects is selected (806). For example, a hinge joint that connects two bodies would normally not be drawn. However, if either attached body is selected, the joint's 3D widget is made visible. This allows the user to use selection to navigate between the different physical entities within the simulation. Fourth, the 3D widget is made visible (810) if it can be used as a target for a join marker (808). For example, the user may drag a join marker to connect a joint widget to the objects the user wants the joint to form a relationship between. A hinge is a suitable parameter to be selected for a gear joint, so 3D widgets for hinges, as well as other suitable target joints, are made visible when a gear joint is selected

A second type among the various types of 3D widgets is axis widgets. Axis widgets are 3D widgets used for representing joints that have position and/or orientation properties. The position and orientation of the 3D widget is applied to the corresponding properties of the joint. For hinge joints and cylindrical joints, both the position and orientation values of the 3D widget are used. The orientation of a hinge joint defines its axis of rotation and the position defines the center of rotation with respect to the position of the bodies the hinge connects. The same holds for the cylindrical joint, which acts just like a hinge, but by which the two constrained objects are allowed to slide back and forth along the axis of rotation.

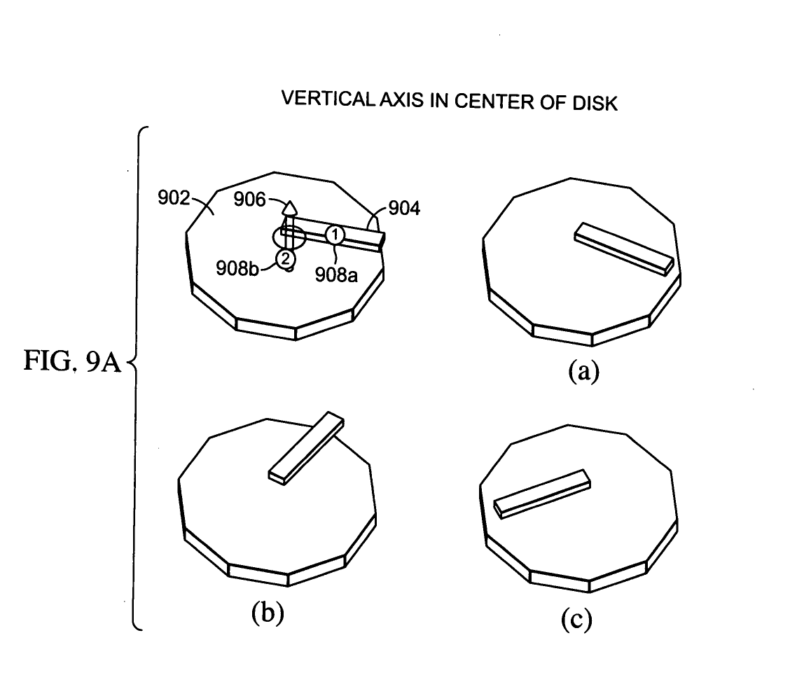

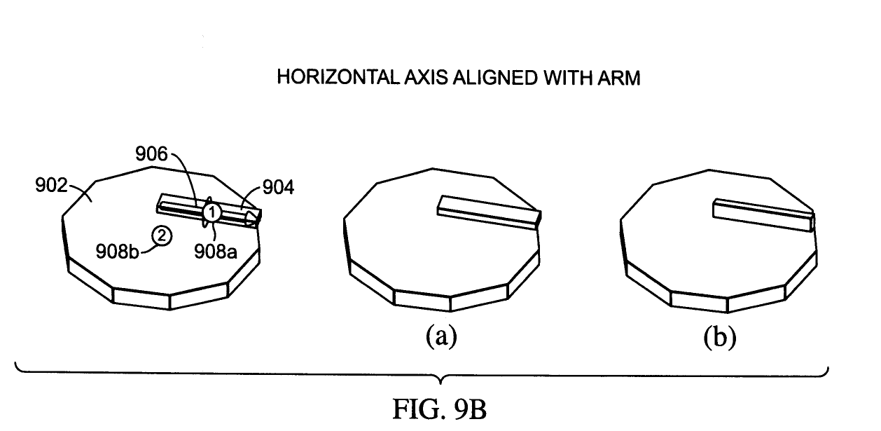

FIGS. 9A and 9B illustrate how the alignment or orientation of a hinge joint affects the objects that it constrains according to one embodiment of the present invention. In FIGS. 9A and 9B, a hinge joint represented by a hinge joint widget 906 constrains a flat disk 902 and an arm 904. Markers 908a and 908b indicate the connections of the arm 904 and the flat disk 902 to the hinge joint 906. If the hinge joint widget 906 is aligned perpendicular to the disk 902 as in FIG. 9A, the arm 904 can turn around the disk 902 like a clock arm, as shown in (a), (b), and (c). However, if the hinge joint widget 906 is aligned along the length of the arm 904 as in FIG. 9B, the arm 904 rotates like a pencil rolling on a desk as shown in (a), and (b).

For other types of joints, only the orientation or only the position may be used. For prismatic joints, only the orientation is needed. A prismatic joint defines a linear relationship where two bodies may slide back and forth towards and away from one another but are not allowed to rotate with respect to the other. In this case, the position property of the 3D widget is ignored. A ball joint connects two bodies at a single point but allows each to rotate freely. The ball joint uses only the position parameter of its 3D widget and ignores the orientation.

In these embodiments, axis widgets that are used to specify an orientation are drawn as slender arrows that point in the canonical direction of the joint. For rotating joints, the direction is perpendicular to the plane of rotation using the right-hand rule. For linear joints, the arrow points in the direction of positive motion.

A third type of 3D widget is a constraint widget. Joints that form constraints but are not positioned within the 3D environment are still represented with 3D widgets. The user can still use the join markers of the 3D widget to connect these joints to their related entities. Also, having the markers alerts the user to the presence of these joints. Since the position of a constraint widget does not matter, the user can place one anywhere and the system would exhibit the same behavior. In general, the user is recommended to place the constraint widgets near the objects they affect.

For example, a gear joint defines a proportional relationship between the angles of two rotating joints. The proportion may be stored in a table or other data structure containing the properties of the gear joint as floating point numbers. A 3D widget is presented for the gear joint in the same manner as other joints. Thus, the user can see to which joints the gear is attached and change the attachment to other joints through direct manipulation. The position of a constraint's 3D widget does not need to be recorded as a joint parameter, and may be stored in a separate data structure. When a user moves and orients a 3D widget, the 3D physical simulation system may store the new values in a “3D widget location table.” Such a location table may also be used for axis widgets that use only part of the positional value. For example, a prismatic joint needs an orientation parameter but not a position so the position may be stored in the location table. A ball joint needs a point position but not an orientation so the orientation may be stored in the location table. The location table may be kept persistent so that the positions of 3D widgets do not change unless specifically moved by the user.

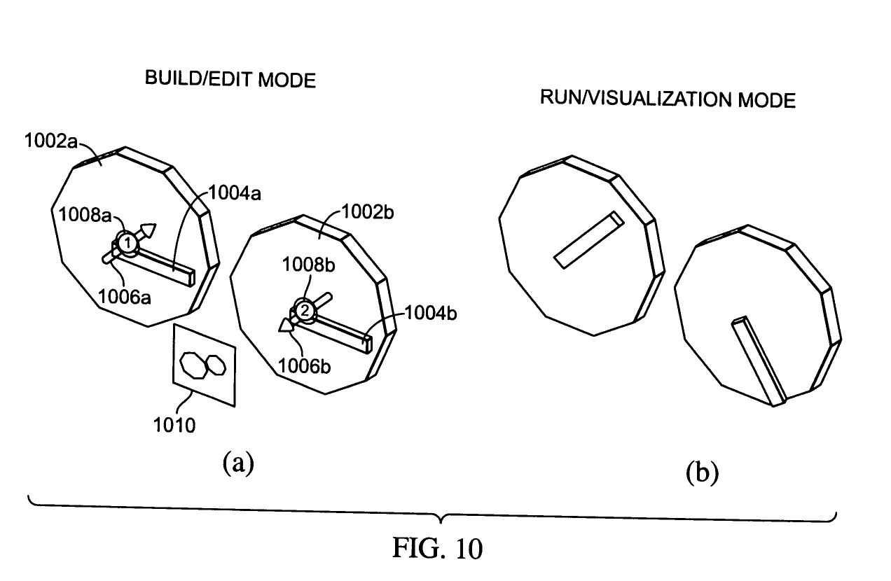

FIG. 10 illustrates a gear joint being used to constrain two hinge joints according to one embodiment of the present invention. A gear joint represented by gear joint widget 1010 includes markers 1008a and 1008b. The gear joint constrains two hinge joints represented by hinge joint widgets 1006a and 1006b as indicated by the markers 1008a and 1008b. Hinge joint 1006a constrains disk 1002a and arm 1004a (as in FIGS. 4-5) and similarly joint 1006b constrains disk 1002b and arm 1004b. The position of the 3D widget will not affect how the hinge joints are constrained. In (a), the hinge joint widgets 1006a and 1006b, the gear joint widget 1010, and the markers 1008a and 1000b are displayed as in a build/edit mode; but they are not displayed in (b) as in a run/visualization mode of the 3D graphical editor.

In addition to 3D widgets, embodiments of the present invention define three types of “markers.” “Material” markers indicate a type of material, “part” markers indicate groupings and attachment of blocks, and “join” markers indicate connections of joints to physical objects or to other joints. These interactive markers allow the user to visualize and change properties of physical entities and joints. The markers may represent materials and connections between entities and/or joints. The markers may be displayed as 2D icons that are drawn near the visual representation of the entity or joint. Multiple markers attached to the same objects may be spread out so as not to overlap. In these embodiments, markers are moved to maintain their relative position to the object when the graphical object is moved. Markers for different purposes are drawn with different colors and images so that they can be recognized.

The user may interact with a marker, for example, by dragging the marker. Markers may be dragged across the screen over the 3D graphical objects in a scene. The 3D physical simulation system may test whether the graphical object the marker is currently over can be used as a parameter for the joint or entity from which the marker originates. If it is a valid parameter, the system may highlight the graphical object. If the user moves away from the object, the highlight is eliminated. When the user stops dragging, the system changes a property of the originating entity or joint depending on what kind of marker was being dragged and the kind of physical object that the marker was dropped over.

Preferably, markers are visible when the originating entity or joint is selected. At other times, the markers are not visible in order to reduce clutter. Some embodiments also provide graphical display modes where certain kinds of markers are made visible even when their originating object is not selected. For example, when a material display mode is activated, all material markers are presented regardless whether a block is selected.

Having described markers generally, each type of marker will be described in more detail, beginning with material markers. As was previously described, block entities represent geometric surfaces in the physics engine. One property of a surface may be its material. A material is a physics object that can be shared among blocks and represents the properties of a kind of material. The properties of a material may include, for example, friction and restitution. Embodiments of the present invention place a “material” marker near the graphical representation of a block to display the block's material. A user may manipulate the material marker to modify the material of the block.

A block with an empty material property has no material marker. A user may create a new material using standard graphical editor techniques such as dragging a selection from a palette. The user can also drag a material marker to other blocks in the scene. If the user drops the material marker over a block, that block is assigned to have the same material. If the user drops the marker over a block with the same material being dragged or does not drop the marker on a block, then nothing happens with respect to the markers or the materials.

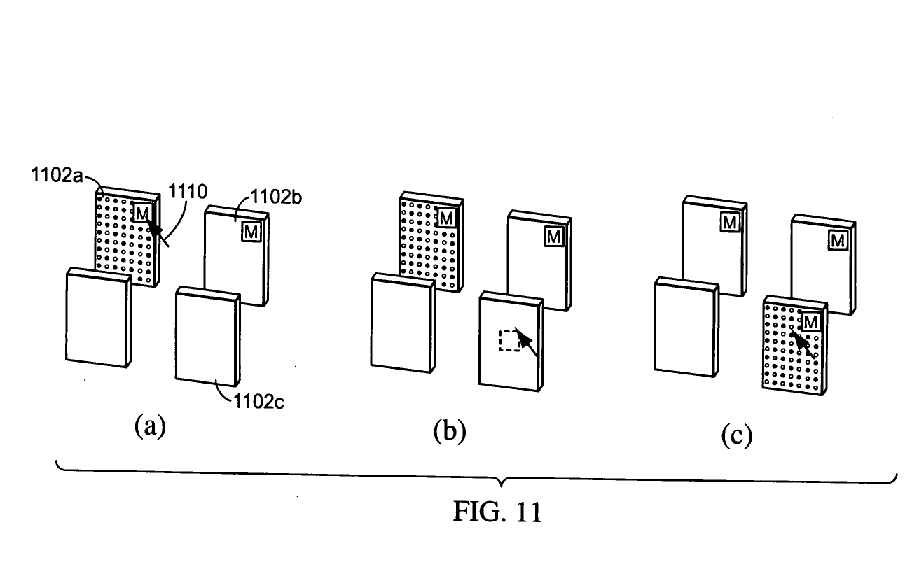

FIG. 11 illustrates the process of sharing a material between two blocks using material markers according to one embodiment of the present invention. In (a), block 1102a has a material marker indicating a first material type. Block 1102b has a different material marker indicating a second material type. Block 1102c has no material marker. In (a), the material marker on block 1102a is highlighted and selected by a cursor 1110. In (b), the cursor 1110 and a copy of the material marker have been dragged to block 1102c. In (c), the cursor 1110 remains on block 1102c, and the material marker from block 1102a has been copied to block 1102c, so that blocks 1102a and 1102c share the same material type.

Preferably, material markers are displayed on the graphical representation of blocks. However, displaying all material markers for all blocks can cause clutter, so embodiments of the present invention may display material markers sparingly. For example, a material marker may be made visible when the block that uses it is selected. Also, the marker for all other blocks that share the same material may also be made visible. This allows a user to see which blocks share a given material.

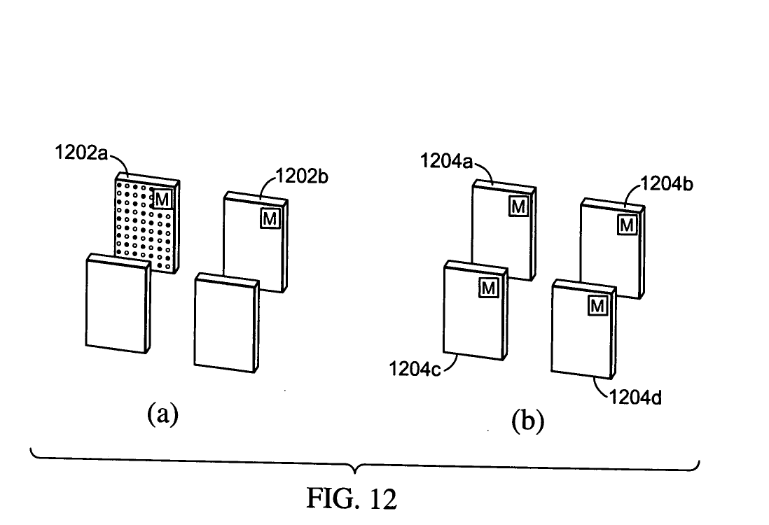

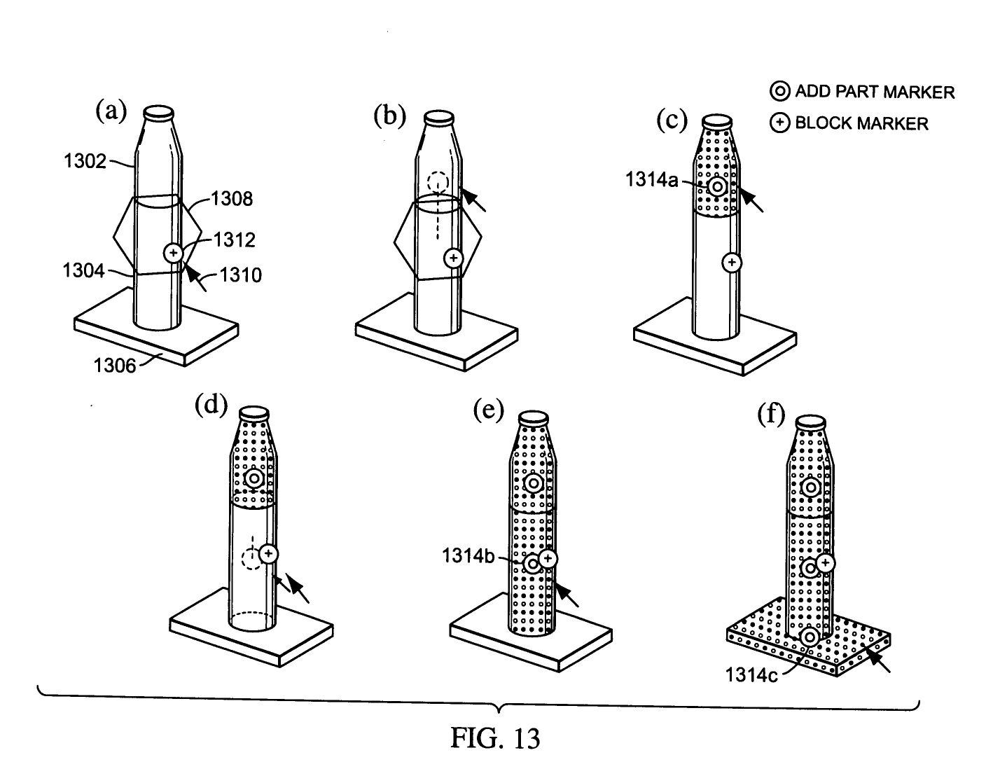

FIG. 12 illustrates how different materials are indicated by different material markers according to one embodiment of the present invention. In (a), there are four block entities. Block 1202a is selected. Block 1202b has the same material as 1202a because both markers are displayed. Each material object may be assigned a different color, pattern, or other indicia and the markers for that material are drawn using that color, pattern, or indicia. A user may select a mode to display all material markers in which case all material markers are made visible. The user can see which materials are different, for example, by noting the different colors. In (b), four blocks are shown. In this case, only blocks 1204a and 1204b share the same material because the colors of their material markers are the same.

A second type of marker is the “part” marker. As was previously described, body entities are defined as representing physical objects that move in the physics engine. The geometry shape of a body is defined by composing block entities within the body. Embodiments of the present invention allow adding and removing of blocks from a body using “part” markers. There are two kinds of part markers. The first is the “add part” marker and is placed near the body entity. It may be used to add new blocks to a body. The second kind is the “block” marker and is replicated for each block within a body. Block markers are placed near the block they attach. Both add part and block markers are considered to be originating from the body entity.

FIG. 13 illustrates the use of part markers to add blocks to a body according to one embodiment of the present invention. In (a), three blocks are shown, including a bottle block 1302, a cylinder block 1304, and a rectangular plate block 1306. A body widget 1308 (displayed as a hexagonal outline) is shown and includes an add part marker 1312. Control is achieved through a cursor 1310, shown here as an arrow. In (b), the add part marker 1312 has been dragged over the bottle block 1302, which is highlighted. In (c), the add part marker 1312 is “dropped” over the bottle block 1302, so that the bottle block 1302 is added to the body. The body widget 1308 is no longer displayed, since the body has a defined geometry. A block marker 1314a is displayed as part of the body. In (d), the add part marker 1312 has been dragged to the cylinder block 1304, which is highlighted. In (e), the add part marker 1312 is dropped over the cylinder block 1304, so that the cylinder block 1304 is added to the body. A block marker 1314b is added to the block. In (f), the rectangular plate block 1306 has been added to the body, and a block marker 1314c has been added.

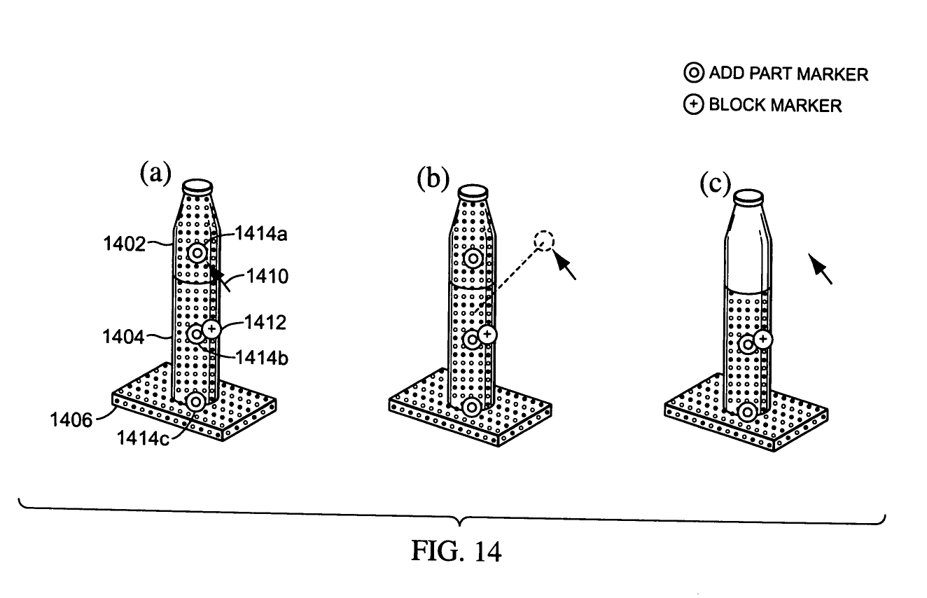

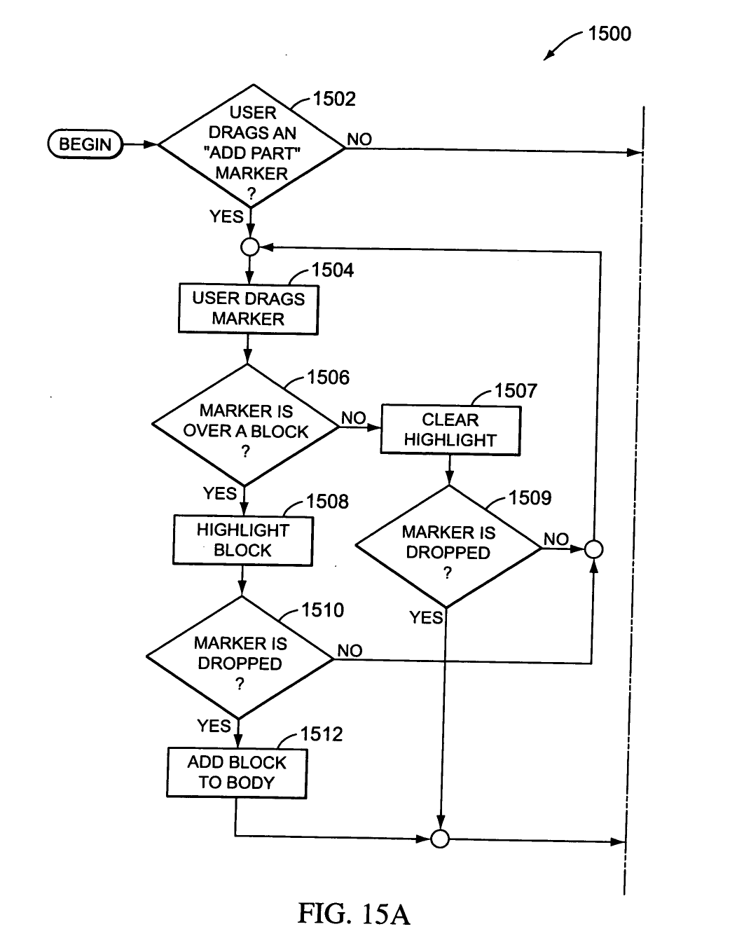

FIG. 14 illustrates the use of part markers to remove blocks from a body according to one embodiment of the present invention. A block marker can be dragged just like an add part marker. If a block marker is dragged and dropped away from the block that it attaches, the block is removed from the body. In (a), a body consists of a bottle block 1402, a cylinder block 1404, and a rectangular plate block 1406 which have block markers 1414a, 1414b, and 1414c, respectively. The body also includes an add part marker 1412. Control is achieved by using a cursor 1410. In (b), the block marker 1414a has been dragged away from the body, thereby removing the bottle block from the body. In (c), the block marker 1414a has been removed, and the bottle block 1402 is shown in a different color from the body. The bottle block 1402 will remain in the simulation as an immobile geometric shape.

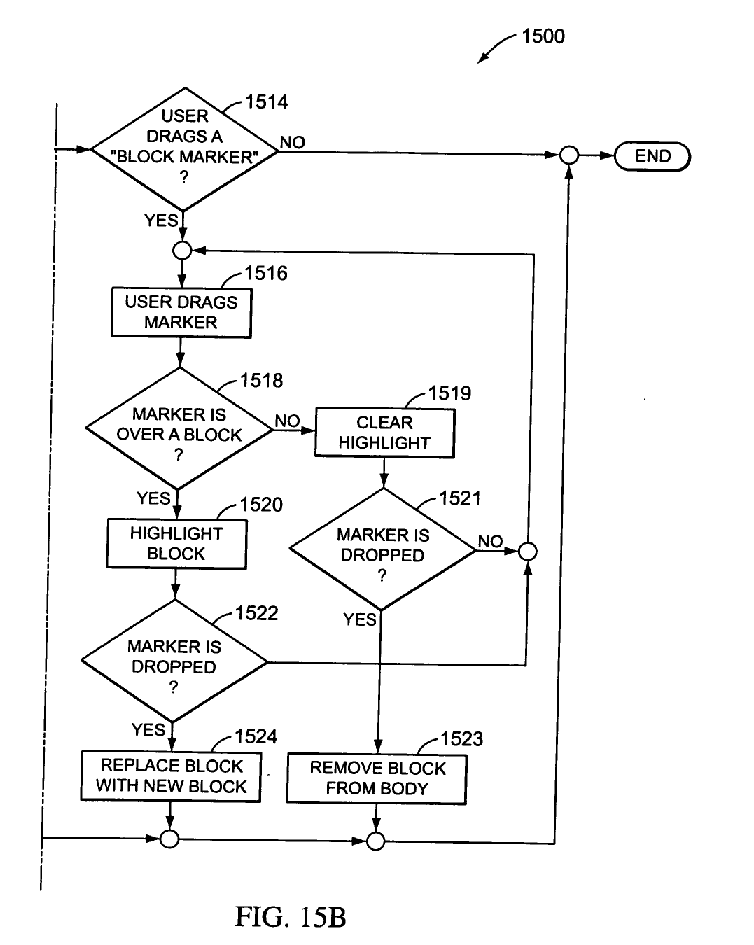

FIGS. 15A and 15B presents a flow diagram of a method 1500 for adding, removing, and replacing blocks using markers according to one embodiment of the present invention. When a user drags an add part marker (1502, 1504) over a block (1506), the block is highlighted (1508). If the add part marker is not over a block, then highlighting is cleared (1507). If the add part marker is dropped over a block (1510), the block is added to the body associated with the add part marker (1512). If the add part marker is dropped while not over a block (1509) then no block is added to the body. Similarly, when a block marker is dragged (1514, 1516) over a block (1518), the block is highlighted (1520). If the block marker is not over a block, then highlighting is cleared (1519). If the block marker is dropped over a block (1522), then the block is replaced by the new block corresponding to the dragged block marker (1524). If the block marker is dropped while not over a block (1521), then the corresponding block is removed from the body (1523).

A third type of marker is a “join” marker. As was previously described, joints are physical objects in the physics engine that may be used to represent constraining relationships among physical entities such as bodies or other joints. Since joints form relationships, the objects being related are important properties of the joint. Embodiments of the present invention display join markers to show what objects the joint connects. One join marker is displayed for each object a joint can connect. The join markers are displayed with different images to indicate which connection they represent. When a joint connection property is set, the corresponding join marker is displayed near the graphical representation of that entity. When the connection is empty, the marker is displayed near the 3D widget of the joint. The joint markers are made visible when the 3D widget of the joint from which they originate is selected.

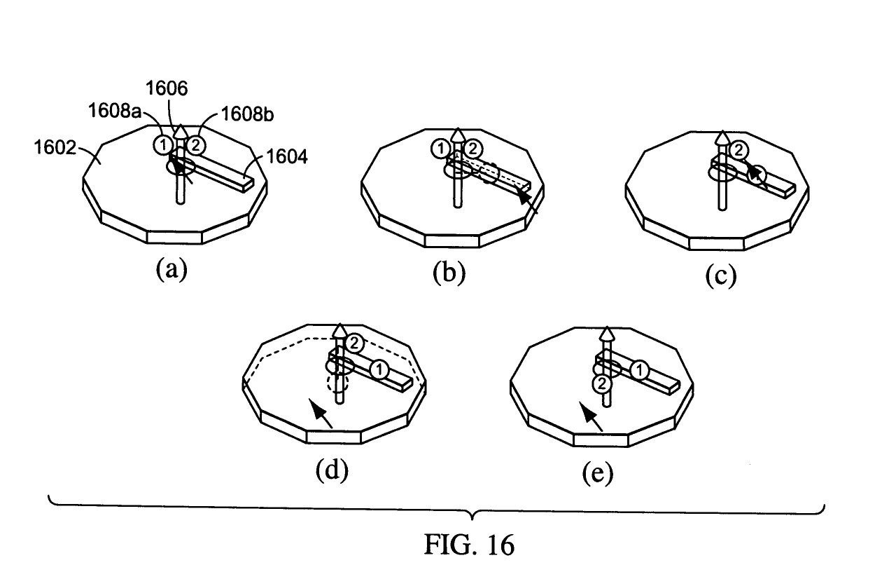

FIG. 16 illustrates the use of join markers according to one embodiment of the present invention. A user can drag the join markers to change the corresponding connection property of the joint. In (a), a flat disk body 1602, an arm body 1604, and a hinge joint widget 1606, including join markers 1608a and 1608b are displayed. In (b), the join marker 1608a has been dragged over the arm body 1604, which is highlighted accordingly. When a user drags a join marker over a graphical object that represents a physics object that the connection property supports, then the 3D graphical editor highlights the object. If the user drops the marker onto a highlighted object, the corresponding connection property is set to the physics object the graphical object represents, as in (c). In (d), the join marker 1608b has been dragged over the disk body 1602, which is highlighted. In (e), the join marker 1608b has been dropped, and the connection property is set to the disk body. If a connection was previously set with another object, the new object replaces it. If the user drops a join marker when no graphical object is highlighted, such as over an empty part of the view, the connection property is set to be empty.

In summary, embodiments of the present invention provide new visible graphical objects within a 3D graphical editor's main view that allow a user to assemble a physical simulation using a physics engine. The user can then manipulate the objects by directly clicking and dragging on them with the mouse or other input device. In prior tools, the kinds of objects presented in a physical simulation application during editing would only be those that would be visible in the actual device. Embodiments of the present invention permit the user to add 3D widget objects to the graphical space where the 3D widgets represent semantic and compositional information for the simulation that would otherwise not be visible. During visualization of the running simulation, the widget objects and markers are not displayed and their semantic effects are apparent in the simulation's behavior.

Embodiments of the present invention define visible graphical objects within a 3D graphical editor's main view. These graphical conventions allow the user to easily view and modify the configuration of a physical simulation using a physics engine. The techniques are provided directly in the 3D view that is normally only used for runtime visualization. Thus, the user does not need to use other views or editors to manipulate many of the important properties of the application.

Embodiments of the present invention include 3D widgets that act as stand-ins to graphically represent objects that would be invisible otherwise. The 3D widgets are used to represent physical entities such as bodies and blocks when the properties of the entities are not sufficient to provide a standard 3D visualization. The 3D widgets are also used to represent joints so that their semantic properties can be manipulated graphically. Embodiments of the present invention also include markers that allow the user to directly manipulate some properties of the physical objects. Material markers represent the material objects that are a property of blocks. Material markers can be dragged to other blocks in order to share the material properties. Part markers are used to attach blocks to bodies. An add part marker associated with the body is used to add more blocks to that body. Block markers show which blocks are currently attached to a body. They may be used to change which blocks are attached to a body and to remove blocks from the body. Join markers are associated with joints and are used to define which physical objects the joint constrains. The markers are used to set, modify, and clear the joint's connection properties.

Using 3D widgets with markers is preferable to using separate editors because the user does not need to relate mentally the objects from one view with the objects in another. Providing graphical tools within the editor is preferable to menu-based techniques because the user can see and control the objects within the simulation. The graphics make semantic relationships readily apparent and the user can change the relationships using direct manipulation. The graphics also provide a focal point where the user can learn the aspects of the physical simulation model and see errors in order to correct them. Using 3D widgets and markers to edit 3D physical simulations is a direct method that is easy for a user to learn and practice.

While the invention has been described and illustrated in connection with preferred embodiments, many variations and modifications may be made without departing from the spirit and scope of the invention. Thus, the invention as recited in the following claims is not to be limited to the precise details of methodology or construction set forth above as such variations and modification are intended to be included within the scope of the invention.

We claim:

1. A graphical simulation system for physical simulation of 3D (three-dimensional) objects, comprising:
a display;
a memory containing a graphical simulation program with program code for physical simulation of 3D objects; and
a processor operatively connected to the memory and the display and adapted to execute the graphical simulation program with the program code adapted to cause the processor to:
instantiate a 3D graphical editor;
assemble a physical simulation via the 3D graphical editor, including by
creating a graphical representation of 3D objects with properties via the 3D graphical editor, and
creating widgets via the 3D graphical editor, each widget representing a 3D object or a semantic relationship to at least one 3D object; and
initiate a physical simulation session to manipulate one or more of the properties of the 3D objects and widgets.

2. The graphical simulation system as in claim 1, wherein the properties of each of the 3D objects include one or more of mass, position, orientation, and motion properties.

3. The graphical simulation system as in claim 2, wherein the motion properties include one or more of velocity, acceleration and inertia.

4. The graphical simulation system as in claim 1, wherein the properties of each widget include one or more of shape, position, and orientation.

5. The graphical simulation system as in claim 1, wherein the widgets are 3D shaped.

6. The graphical simulation system as in claim 1, wherein the widgets include one or more of entity widgets, axis widgets, and constraint widgets.

7. The graphical simulation system as in claim 1, wherein the widgets include one or more joints and wherein each semantic relationship associated with a joint represents a connection to one of the 3D objects, a connection between 3D objects, or a connection to another joint.

8. The graphical simulation system as in claim 7, wherein the program code is further adapted to cause the processor to display a joint widget via the 3D graphical editor if the joint properties are defined, if the joint is selected, if a connected object is selected, or if a selected object can be used as a connection to the joint.

9. The graphical simulation system as in claim 7, wherein the one or more joints comprise a gear, a hinge, a cylindrical joint, a prismatic joint, or a ball joint.

10. The graphical simulation system as in claim 1, wherein the program code is further adapted to cause the processor to create one or more blocks when assembling the physical simulation, wherein each block represents a geometric shape and a surface.

11. The graphical simulation system as in claim 10, wherein each block is associated with one or independent from all of the 3D objects.

12. The graphical simulation system as in claim 10, wherein each block has properties including one or more of position, orientation, geometric shape and material.

13. The graphical simulation system as in claim 9, wherein the 3D graphical editor is adapted to provide palettes and wherein the blocks and objects represented by widgets are selectable from the palettes.

14. The graphical simulation system as in claim 1, wherein the graphical editor is adapted to display widgets during the assembly or editing of the physical simulation.

15. The graphical simulation system as in claim 1, wherein the program code is further adapted to cause the processor to create one or more markers when assembling the physical simulation, wherein each marker is initially associated with a 3D object or a widget and can be dragged to another 3D object or widget.

16. The graphical simulation system as in claim 15, wherein each marker is a material marker, a part marker, or a join marker.

17. The graphical simulation system as in claim 15, wherein material markers specify material properties of objects including one or more of friction and restitution.

18. The graphical simulation system as in claim 15, wherein part markers specify groupings and attachments of blocks.

19. The graphical simulation system as in claim 15, wherein join markers specify connections of joints to one or more blocks.

20. The graphical simulation system as in claim 18, wherein the graphical editor is adapted to add a block or replace a block in a body when a part marker is dragged over a block or remove a block when a part marker is dragged away from a body.

21. In a graphical simulation system for physical simulation of 3D (three-dimensional) objects, a method comprising:
instantiating a 3D graphical editor;
assembling a physical simulation via the 3D graphical editor, including by
creating a graphical representation of 3D objects with properties via the 3D graphical editor, and
creating widgets via the 3D graphical editor, each widget representing a 3D object or a semantic relationship to at least one 3D object; and
initiating a physical simulation session to manipulate one or more of the properties of the 3D objects and widgets.

22. The method as in claim 21, wherein the properties of each of the 3D objects include one or more of mass, position, orientation, and motion properties.

23. The method as in claim 21, wherein the motion properties include one or more of velocity, acceleration and inertia.

24. The method as in claim 21, wherein the properties of each widget include one or more of shape, position, and orientation.

25. The method as in claim 21, wherein the widgets are 3D shaped.

26. The method as in claim 21, wherein the widgets include one or more of entity widgets, axis widgets, and constraint widgets.

27. The method as in claim 21, wherein the widgets include one or more joints and wherein each semantic relationship associated with a joint represents a connection to one of the 3D objects, a connection between 3D objects, or a connection to another joint.

28. The method as in claim 27, wherein a joint is displayed if the joint properties are defined, if the joint is selected, if a connected object is selected, or if a selected object can be used as a connection to the joint.

29. The method as in claim 27, wherein the one or more joints comprise a gear, a hinge, a cylindrical joint, a prismatic joint, or a ball joint.

30. The method as in claim 21, wherein assembling the physical simulation further includes creating one or more blocks, wherein each block represents a geometric shape and a surface.

31. The method as in claim 30, wherein each block is associated with one or independent from all of the 3D objects.

32. The method as in claim 30, wherein each block has properties including one or more of position, orientation, geometric shape and material.

33. The method as in claim 30, wherein the 3D graphical editor is adapted to provide palettes and wherein the blocks and objects represented by widgets are selectable from the palettes.

34. The method as in claim 21, wherein the widgets are displayed during the assembly or editing of the physical simulation.

35. The method as in claim 21, wherein assembling the physical simulation further includes creating one or more markers, wherein each marker is initially associated with a 3D object or a widget and can be dragged to another 3D object or widget.

36. The method as in claim 35, wherein each marker is a material marker, a part marker, or a join marker.

37. The method as in claim 36, wherein material markers specify material properties of objects including one or more of friction and restitution.

38. The method as in claim 36, wherein part markers specify groupings and attachments of blocks.

39. The method as in claim 36, wherein join markers specify connections of joints to one or more blocks.

40. The method as in claim 38, wherein the dragging of a part marker over another block adds or replaces a block in a body.

41. The method as in claim 38, wherein the dragging of a part marker away from a body removes a block from the body.
